(19) United States
(12) Patent Application Publication
(10) Pub. No.: US 2011/0132551 A1
(43) Pub. Date: Jun. 9, 2011

(54) Method For Removing Non-Reacted Isocyanate From Its Reaction Product

(76) Inventors: Simone Klapdohr, Rosenheim (DE); Burkhard Walther, Garching (DE); Helmut Mack, Traunstein (DE); Zhizhong Cai, Trostberg (DE); Laurent Marc, Hericy (FR); Jochen Mezger, Garching an der Alz (DE); Tobias Austermann, Munster (DE); Silke Flakus, Ebersberg (DE)

(21) Appl. No.: 13/002,169

(22) PCT Filed: Jun. 16, 2009
(86) PCT No.: PCT/EP2009/057414

§ 371 Date: Feb. 18, 2011

(30) Foreign Application Priority Data
Jul. 8, 2008 (EP) 08104668.2

(51) Int. Cl. B01D 1/22

(52) U.S. Cl. 159/49

(57) ABSTRACT

The present invention relates to a method for removing isocyanate from a reaction product of isocyanate with compounds reactive towards isocyanates, the reaction product being applied to the surface of a rotating body A, the reaction product flowing over the surface of the rotating body A to an outer region of the surface of the rotating body A and isocyanate which was used for the preparation of the reaction product and has not reacted evaporating from the mixture in the process.

The present invention relates to a method for removing isocyanate from a reaction product of isocyanate with compounds reactive towards isocyanates.

Isocyanates are valuable raw materials and are used, for example, for the preparation of polyurethanes and polyureas. For this purpose, the isocyanates are reacted with polyalcohols and polyamines, respectively. The products obtained play an important role, for example, in the industrial production of chemicals, adhesives, plastics and paints. Owing to the molar mass distribution formed in the production, however, the reaction products frequently still contain amounts of unreacted monomeric isocyanates or low molecular weight reaction products which have isocyanate groups. These may escape in gaseous form from the reaction products and, being irritant, sensitive or toxic substances, constitute a health hazard for the processor and end customers. Furthermore, the monomeric isocyanates or low molecular weight reaction products remaining in the product may disadvantageously affect the product properties.

A known method for removing monomeric diisocyanate and low molecular weight reaction products from reaction mixtures is distillation. Thus, for example, EP 105242A2 discloses reduction of the remaining monomer content of a reaction product of isocyanate by distillation with the aid of a thin-film evaporator, the reaction product first being diluted with an inert solvent. However, this has the disadvantage that at least a part of the inert solvent remains in the product and can lead to problems in the following applications. In the case of product changes, complicated cleaning of the apparatus is also necessary. Furthermore, this method according to the prior art employs complicated apparatus and is therefore expensive.

It was therefore an object of the present invention to provide an economical method for removing isocyanate from a reaction product of isocyanate with compounds reactive towards isocyanates, which method is flexible in terms of the process. The method should be capable of being carried out in a simple manner and should ensure a good and reproducible product quality. Furthermore, highly viscous reaction products should also be capable of being purified without the addition of an inert solvent.

This object is achieved by a method for removing isocyanate from a reaction product of isocyanate with compounds reactive towards isocyanates, the reaction product being applied to the surface of a rotating body A, the reaction product flowing over the surface of the rotating body A to an outer region of the surface of the rotating body A and isocyanate which was used for the preparation of the reaction product and has not reacted evaporating from the mixture in the process.

The rotating body A may be disc-shaped, vase-shaped, annular or conical, a horizontal rotating disc or a rotating disc deviating from the horizontal by up to 45° being regarded as being preferred. Usually, the body A has a diameter of 0.10 m to 3.0 m, preferably 0.20 m to 2.0 m and particularly preferably of 0.20 m to 1.0 m. The surface may be smooth or may have, for example, ripple-like or spiral mouldings which influence the residence time of the reaction mixture. Expediently, the body A is installed in a container which is resistant with regard to the conditions of the method according to the invention.

The rotational velocity of the body A and the metering rate of the reaction product are variable. Usually, the rate of revolution in revolutions per minute is 1 to 20 000, preferably 100 to 5000 and particularly preferably 500 to 3000. The volume of the reaction product which is present per unit area of the hot surface on the rotating body A is typically 0.03 to 40 ml/dm², preferably 0.1 to 10 ml/dm², particularly preferably 1.0 to 5.0 ml/dm². The average residence time (frequency mean of the residence time spectrum) of the mixture is, inter alia, dependent on the size of the surface, on the type of reaction product and on the isocyanate present, on the temperature of the surface and on the rate of revolution of the rotating body A and is usually between 0.01 and 60 seconds, particularly preferably between 0.1 and 10 seconds, in particular 1 to 7 seconds, and is thus to be regarded as being extremely short. This ensures that the extent of possible decomposition reactions and the formation of undesired products are greatly reduced and hence the quality of the substrates is maintained.

In a preferred embodiment of the invention, the removal of the isocyanate is carried out by means of an apparatus which has
α) a body A rotating about a preferably centrally arranged axis of rotation and
β) a metering system.

In a further embodiment, the apparatus may have a quench device. The quench device is preferably present as at least one cooling wall which surrounds the rotating disc and which the reaction product strikes after leaving the surface. In this embodiment, the method according to the invention ensures that the reaction product from which the isocyanate is to be removed can be strongly heated by the body A in a very short time, thermally promoted, undesired secondary reactions being prevented by the subsequent quenching. The abrupt cooling by means of the quench device is effected within at most five seconds, preferably within only one second.

For effective removal of the isocyanate, it may also be expedient to pass the reaction product several times over the surface of the rotating body A. In a further embodiment of the invention, the surface extends to further rotating bodies so that the reaction product passes from the surface of the rotating body A to the surface of at least one further rotating body. The further rotating bodies are expediently constituted to correspond to the body A. Typically, body A then feeds the further bodies with the reaction product. The reaction product leaves this at least one further body and, if required, can then be abruptly cooled by means of the quench device.

It is to be regarded as being preferred that the reaction product is present on the surface of the rotating body A in the form of a film which has an average thickness between 0.1 μm and 6.0 mm, preferably between 60 and 1000 μm, particularly preferably between 100 and 500 μm.

The method according to the invention can be carried out at atmospheric pressure or slightly superatmospheric pressure and also in an atmosphere of dry inert gas. However, it may also be expedient to generate a vacuum, in general pressures between 0.001 mbar and 1100 mbar, particularly preferably between 0.01 mbar and 40 mbar, in particular between 0.02 mbar and 20 mbar, having proved to be advantageous. A preferred embodiment of the present invention furthermore envisages that the evaporated isocyanate will be expelled with a gas or dry air, in particular inert gas. It is furthermore to be regarded as being preferred that at the same time a vacuum is applied and the evaporated isocyanate is expelled with a gas or dry air, in particular inert gas.

The temperature of the rotating body A, in particular of the surface facing the mixture, may be varied in wide regions and depends both on the reaction products used, the isocyanate and the residence time on the body A and on the pressure. Temperatures between 70 and 300° C., particularly preferably between 25 and 270° C., in particular between 150 and 250° C. have proved to be expedient. The rotating body A and/or the reaction product can be heated, for example electrically, with a heat-transfer liquid, with vapour, with a laser, with microwave radiation or by means of infrared radiation.

It has furthermore proved to be expedient to condense the evaporated isocyanate on a body having a temperature between −196° C. and 120° C., particularly preferably between −78 and 20° C., in particular between −78 and 0° C. In this context, a preferred embodiment envisages surrounding the rotating body A with at least one surface on which isocyanate can condense, it being preferred that the surface has an inclination so that the condensed isocyanate is removed from the rotating body A by gravitation along the surface.

However, it may also be expedient to heat the surfaces surrounding the body A in order to prevent condensation of isocyanate. In this embodiment, the evaporated isocyanate can be removed by a vacuum or an inert gas stream.

The isocyanate content of the reaction products used is not critical. In particular, the method according to the invention is suitable if the isocyanate content of the reaction products used is between 0.01 and 95% by weight, particularly preferably between 0.1 and 75% by weight, in particular between 0.2 and 67% by weight, based on the total weight of the reaction product, directly before the application to the surface of the rotating body A. Here, it is to be regarded as being preferred that the isocyanate content in the mixture after removal of the isocyanate by evaporation on the surface of the rotating body A is between 0.001 and 10% by weight, particularly preferably between 0.02 and 5% by weight, in particular between 0.05 and 2% by weight, based on the total weight of the reaction product.

Isocyanate is preferably an aliphatic, cycloaliphatic, araliphatic and/or aromatic compound, preferably a diisocyanate or triisocyanate, mixtures of these compounds also being possible. Here, it is to be regarded as being preferred that the reaction product is based on the reaction of hexamethylene 1,6-diisocyanate (HDI), 1-isocyanato-3,3,5-trimethyl-5-isocyanatomethylcyclohexane (IPDI), 2,4- and/or 2,6-toluylene diisocyanate (TDI) and/or 4,4′-, 2,4′- and/or 2,2′-diphenylmethane diisocyanate (MDI), m-xylene diisocyanate (MXDI), m- or p-tetramethylxylene diisocyanate (m-TMXDI, p-TMXDI), 4,4′-dicyclohexylmethane diisocyanate (H12MDI), naphthalene 1,5-diisocyanate, cyclohexane 1,4-diisocyanate, hydrogenated xylylene diisocyanate (H6XDI), 1-methyl-2,4-diisocyanatocyclohexane, tetramethoxybutane 1,4-diisocyanate, butane 1,4-diisocyanate, 1,6-diisocyanato-2,2,4-trimethylhexane, 1,6-diisocyanato-2,4,4-trimethylhexane, 1-isocyanato-1-methyl-4(3)-isocyanatomethylcyclohexane (IMCI) and 1,12-dodecane diisocyanate (C12DI) with compounds reactive towards isocyanates.

The present invention envisages that preferably hexamethylene 1,6-diisocyanate (HDI), 1-isocyanato-3,3,5-trimethyl-5-isocyanatomethylcyclohexane (IPDI), 2,4- and/or 2,6-toluylene diisocyanate (TDI) and/or 4,4′-, 2,4′- and/or 2,2′-diphenylmethane diisocyanate (MDI), m-xylene diisocyanate (MXDI), m- or p-tetramethylxylene diisocyanate (m-TMXDI, p-TMXDI), 4,4′-dicyclohexylmethane diisocyanate (H12MDI), naphthalene 1,5-diisocyanate, cyclohexane 1,4-diisocyanate, hydrogenated xylylene diisocyanate (H6XDI), 1-methyl-2,4-diisocyanatocyclohexane, tetramethoxybutane 1,4-diisocyanate, butane 1,4-diisocyanate, 1,6-diisocyanato-2,2,4-trimethylhexane, 1,6-diisocyanato-2,4,4-trimethylhexane, 1-isocyanato-1-methyl-4(3)-isocyanatomethylcyclohexane (IMCI) and 1,12-dodecane diisocyanate (C12DI) will be removed from the reaction product.

The compounds reactive towards isocyanates are preferably compounds having hydroxyl groups and/or amino groups. Polyetherpolyols, polyesterpolyols, polybutadienepolyols and polycarbonatepolyols are particularly preferred. The polyols and/or polyamines preferably contain between two and 10, particularly preferably between two and three, hydroxyl groups and/or amino groups and have a weight average molecular weight between 32 and 20 000, particularly preferably between 90 and 18 000 g/mol. Suitable as polyols are preferably the polyhydroxy compounds which are liquid, glassy solid/amorphous or crystalline at room temperature. Difunctional polypropylene glycols may be mentioned as typical examples. It is also possible to use random copolymers and/or block copolymers of ethylene oxide and propylene oxide which have hydroxyl groups. Suitable polyetherpolyols are the polyethers known per se in polyurethane chemistry, such as the polyols prepared using initiator molecules from styrene oxide, propylene oxide, butylene oxide, tetrahydrofuran or epichlorohydrin. In particular, poly(oxytetramethylene) glycol (poly-THF), 1,2-polybutylene glycol or mixtures thereof are specifically suitable. In particular, polypropylene oxide and polyethylene oxide and mixtures thereof are suitable. A further copolymer type which can be used as the polyol component and has terminal hydroxyl groups is according to the general formula (preparable, for example, by means of “controlled” high-speed anionic polymerization according to Macromolecules 2004, 37, 4038-4043):

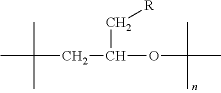

in which R is identical or different and is preferably represented by OMe, OiPr, Cl or Br.

The polyesterdi- or polyols which are liquid, glassy amorphous or crystalline at 25° C. and can be prepared by condensation of di- or tricarboxylic acids, such as adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid and/or dimeric fatty acid, with low molecular weight diols or triols, such as ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimeric fatty alcohol, glycerol and/or trimethylolpropane, are furthermore suitable as the polyol component.

A further suitable group of polyols comprises the polyesters, for example based on caprolactone, which are also referred to as “polycaprolactones”. Further polyols which may be used are polycarbonate-polyols and dimeric diols and polyols based on vegetable oils and their derivatives, such as castor oil and derivatives thereof, or epoxidized soybean oil. Also suitable are polycarbonates which have hydroxyl groups and are obtainable by reaction of carbonic acid derivatives, e.g. diphenyl carbonate, dimethyl carbonate or phosgene, with diols. Ethylene glycol, 1,2- and 1,3-propanediol, 1,3- and 1,4-butanediol, 1,6-hexanediol, 1,8-octanediol, neopentylglycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A, glycerol, trimethylolpropane, hexane-1,2,6-triol, butane-1,2,4-triol, trimethylolpropane, pentaerythritol, chinitol, mannitol, sorbitol, methylglycoside and 1,3,4,6-dianhydrohexite are specifically suitable. The hydroxyl-functional polybutadienes, which are commercially available, inter alia, under the trade name “Poly-bd®”, can also be used as polyols, as can the hydrogenated analogues thereof. Furthermore, hydroxy-functional polysulphides, which are marketed, for example, under the trade name “Thiokol® NPS-282”, and hydroxy-functional polysiloxanes are suitable.

In particular, hydrazine, hydrazine hydrate and substituted hydrazines, such as N-methylhydrazine, N,N′-dimethylhydrazine, acid dihydrazides, adipic acid, methyl-adipic acid, sebacic acid, hydracrylic acid, terephthalic acid, semicarbazidoalkylene hydrazides, such as 13-semicarbazidopropionic acid hydrazide, semicarbazidoalkylene carbazine esters, such as, for example, 2-semicarbazidoethyl carbazine ester, and/or aminosemicarbazide compounds, such as 13-aminoethylsemicarbazidocarbonate, are suitable as polyamines which can be used according to the invention.

Polyamines, for example those which are marketed under the trade name Jeffamine® (these are polyetherpolyamines) are also suitable.

Suitable polyols and/or polyamines are also the species known as so-called chain extenders, which react with excess isocyanate groups in the preparation of polyurethanes and polyureas, usually have a molecular weight of less than 400 and are frequently present in the form of polyols, aminopolyols or aliphatic, cycloaliphatic or araliphatic polyamines.

Examples of suitable chain extenders are:
alkanediols, such as ethanediol, 1,2- and 1,3-propanediol, 1,4- and 2,3-butane-diol, 1,5-pentanediol, 1,3-dimethylpropanediol, 1,6-hexanediol, neopentylglycol, cyclohexanedimethanol, 2-methyl-1,3-propanediol,
etherdiols, such as diethylene diglycol, triethylene glycol or hydroquinone dihydroxyethyl ether,
hydroxybutyl hydroxycaproic acid ester, hydroxyhexyl hydroxybutyric acid ester, hydroxyethyl adipate and bishydroxyethyl terephthalate and
polyamines, such as ethylenediamine, 1,2- and 1,3-diaminopropane, 1,4-diaminobutane, 1,6-diaminohexane, isomer mixtures of 2,2,4- and 2,4,4-trimethylhexamethylenediamine, 2-methylpentamethylenediamine, diethylenetriamine, 1,3- and 1,4-xylylenediamine and 4,4-diaminodicyclohexylmethane

Finally, it should be mentioned that the polyols and/or polyamines may contain double bonds which may result, for example, from long-chain, aliphatic carboxylic acids or fatty alcohols. Functionalization with olefinic double bonds is also possible, for example, by the incorporation of vinylic or allylic groups. These may originate, for example, from unsaturated acids, such as maleic anhydride, acrylic acid or methacrylic acid and the respective esters thereof.

Reaction products which are based on polypropylenediol, polypropylenetriol, polypropylenepolyol, polyethylenediol, polyethylenetriol, polyethylenepolyol, polypropylenediamine, polypropylenetriamine, polypropylenepolyamine, poly-THF-diamine, polybutadienediol, polyesterdiol, polyestertriol, polyesterpolyol, polyesteretherdiol, polyesterethertriol, polyesteretherpolyol, particularly preferably polypropylenediol, polypropylenetriol, poly-THF-diol, polyhexanediol carbamate diol, polycaprolactamdiol, polycaprolactamtriol and water as a compound reactive towards isocyanates are particularly preferred in the context of the invention. Furthermore, mixtures of said compounds are also possible.

In this context, it has proved particularly surprising that the method according to the invention is also suitable in an outstanding manner for removing isocyanate from highly viscous liquids, it being possible to remove even very small amounts of isocyanate effectively. In addition to the viscosity, the chemical properties of the reaction products used also play an important role. The method according to the present invention gives outstanding results both for polyurethanes and for polyureas and for oligomeric isocyanate mixtures. Furthermore, the method according to the invention can be carried out with uncomplicated apparatus, relatively high substance throughputs being possible. Thus, the claimed method provides a very economical alternative to the methods already known, even for the industrial purification of reaction products of isocyanate.

A particular embodiment of the present invention envisages using a reaction product which was prepared by reacting isocyanate with compounds reactive towards isocyanates in a reactor which has
α) a hot body B rotating about a preferably centrally arranged axis of rotation,
β) a metering system and
γ) a quench device,
a) the isocyanate and the compounds reactive towards isocyanates being applied individually and/or as a mixture, optionally with further components, with the aid of the metering system to the surface of the rotating body B so that a film containing compounds reactive towards isocyanates and isocyanate flows over the surface of the rotating body B to an outer region of the hot surface of the rotating body B,
b) the film leaving the surface as a reaction product containing polyurethane and/or polyurea and
c) the reaction composition being cooled abruptly by means of the quench device after leaving the hot surface,
   the temperature of the surface of the rotating body B being between 70 and 300° C., particularly preferably between 160 and 250° C., and the abrupt cooling of the reaction composition effected by means of the quench device being at least 30° C.

The quench device is in general preferably present in the form of one or more cooling walls which permit the abrupt cooling of the reaction mixture. The cooling walls, which are frequently cylindrical or conical, have either a smooth or a rough surface, the temperature of which is typically between −50° C. and 200° C. The abrupt cooling of the reaction composition effected by means of the quench device is preferably at least 50° C., preferably at least 100° C.

Here, the hot rotating body B is expediently constituted to correspond to the body A. Particularly advantageous here is that both the preparation of the reaction product of isocyanate with compounds reactive towards isocyanates and the removal of the isocyanate from the reaction product can be carried out with the same apparatus.

The molar ratio of the isocyanate groups of the isocyanate component used to the sum of the amino groups and/or hydroxyl groups of the polyols and/or polyamines used is preferably between 0.1 and 20, particularly preferably between 1.3 and 10, in particular between 1.8 and 5.

Advantageously, a catalyst suitable for the preparation of polyurethanes or polyureas is used as a component of the starting reaction mixture in the method according to the invention. Suitable catalysts are the customary catalysts of polyurethane chemistry which are known per se, such as acids, e.g. para-toluenesulphonic acid, or tertiary amines, such as, for example, triethylamine, triethylenediamine (DABCO) or those which have atoms such as, for example, Sn, Mn, Fe, Co, Cd, Ni, Cu, Zn, Zr, Ti, Hf, Al, Th, Ce, Bi, Hg, N or P. The molar ratio of catalyst to isocyanate is dependent on the type of isocyanate and on the type of catalyst and is usually between 0 and 0.1, preferably 0 to 0.03.

The temperature of the hot body B and the contact time on this body are preferably established so that between 5 and 99.99% by weight of the maximum amount of isocyanate groups which can be reacted with the amount of polyol and optionally amine used have preferably reacted with hydroxyl and optionally amino groups of the polyol and optionally amine.

1. Method for removing isocyanate from a reaction product of isocyanate with compounds reactive towards isocyanates, wherein the reaction product is applied to the surface of a rotating body A, the reaction product flowing over the surface of the rotating body A to an outer region of the surface of the rotating body A and isocyanate which was used for the preparation of the reaction product and has not reacted evaporating from the mixture in the process.

2. Method according to claim 1, wherein the rotating body A is present as a rotating disc, to the surface of which the reaction product is applied.

3. Method according to claim 1, wherein the removal of the isocyanate is carried out by means of an apparatus which has
α) a body A rotating about an axis of rotation and
β) a metering system.

4. Method according to claim 1, wherein the reaction product is present on the surface of a rotating body A in the form of a film which has an average thickness between 0.1 μm and 6.0 mm.

5. Method according to claim 1, wherein the average residence time of the ingredients of the reaction product on the surface of the rotating body is between 0.01 and 60 seconds.

6. Method according to claim 1, wherein the temperature of the rotating body is between 70 and 300° C.

7. Method according to claim 1, wherein the pressure at which the isocyanate is removed is between 0.001 mbar and 1100 mbar.

8. Method according to claim 1, wherein the evaporated isocyanate condenses on a body having a temperature between −196° C. and 120° C.

9. Method according to claim 1, wherein the content of isocyanate is between 0.01 and 95% by weight, based on the total weight of the reaction product, directly before the application of the substrate to the surface of the rotating body A.

10. Method according to claim 1, wherein the content of isocyanate in the reaction product is between 0.001 and 10% by weight, based on the total weight of the reaction product, after the evaporation of the isocyanate on the surface of a rotating body A.

11. Method according to claim 1, wherein the reaction product is based on the reaction of hexamethylene 1,6-diisocyanate (HDI), 1-isocyanato-3,3,5-trimethyl-5-isocyanatomethylcyclohexane (IPDI), 2,4- and/or 2,6-toluylene diisocyanate (TDI) and/or 4,4′-, 2,4′- and/or 2,2′-diphenylmethane diisocyanate (MDI), m-xylene diisocyanate (MXDI), m- or p-tetramethylxylene diisocyanate (m-TMXDI, p-TMXDI), 4,4′-dicyclohexylmethane diisocyanate (1112MDI), naphthalene 1,5-diisocyanate, cyclohexane 1,4-diisocyanate, hydrogenated xylylene diisocyanate (H6XDI), 1-methyl-2,4-diisocyanatocyclohexane, tetramethoxybutane 1,4-diisocyanate, butane 1,4-diisocyanate, 1,6-diisocyanato-2,2,4-trimethylhexane, 1,6-diisocyanato-2,4,4-trimethylhexane, 1-isocyanato-1-methyl-4(3)-isocyanatomethylcyclohexane (IMCI), 1,12-dodecane diisocyanate (C12DI) or mixtures thereof with compounds reactive towards isocyanates.

12. Method according to claim 11, wherein hexamethylene 1,6-diisocyanate (HDI), 1-isocyanato-3,3,5-trimethyl-5-isocyanatomethylcyclohexane (IPDI), 2,4- and/or 2,6-toluylene diisocyanate (TDI) and/or 4,4′-, 2,4′- and/or 2,2′-diphenylmethane diisocyanate (MDI), m-xylene diisocyanate (MXDI), m- or p-tetramethylxylene diisocyanate (m-TMXDI, p-TMXDI), 4,4′-dicyclohexylmethane diisocyanate (1112MDI), naphthalene 1,5-diisocyanate, cyclohexane 1,4-diisocyanate, hydrogenated xylylene diisocyanate (H6XDI), 1-methyl-2,4-diisocyanatocyclohexane, tetramethoxybutane 1,4-diisocyanate, butane 1,4-diisocyanate, 1,6-diisocyanato-2,2,4-trimethylhexane, 1,6-diisocyanato-2,4,4-trimethylhexane, 1-isocyanato-1-methyl-4(3)-isocyanatomethylcyclohexane (IMCI) and/or 1,12-dodecane diisocyanate (C12DI) are removed from the reaction product.

13. Method according to claim 1, wherein the reaction product is based on polypropylenediol, polypropylenetriol, polypropylenepolyol, polyethylenediol, polyethylenetriol, polyethylenepolyol, polypropylenediamine, polypropylenetriamine, polypropylenepolyamine, poly-THF-diamine, polybutadienediol, polyesterdiol, polyestertriol, polyesterpolyol, polyesteretherdiol, polyesterethertriol, polyesteretherpolyol, polypropylenediol, polypropylenetriol, poly-THF-diol, polyhexanediol carbamate diol, polycaprolactamdiol, polycaprolactamtriol, water or mixtures thereof as compounds reactive towards isocyanates.

14. Method according to claim 1, wherein a reaction product is used which was prepared by reacting isocyanate with compounds reactive towards isocyanates in a reactor which has
α) a hot body B rotating about an axis of rotation,
β) a metering system and
γ) a quench device,
a) the isocyanate and the compounds reactive towards isocyanates being applied individually and/or as a mixture, optionally with further components, with the aid of the metering system to the surface of the rotating body B so that a film containing compounds reactive towards isocyanates and isocyanate flows over the surface of the rotating body B to an outer region of the hot surface of the rotating body B,
b) the film leaving the surface as a reaction product containing polyurethane and/or polyurea and
c) the reaction product being cooled abruptly by means of the quench device after leaving the hot surface,
the temperature of the surface of the rotating body B being between 70 and 300° C. and the abrupt cooling of the reaction composition product effected by means of the quench device being at least 30° C.
